(19) United States
(12) Patent Application Publication
(10) Pub. No.: US 2013/0054312 A1
(43) Pub. Date: Feb. 28, 2013

(54) DISTRIBUTED ENERGY CONTRIBUTION-BASED COMMUTING

(71) Applicants: David B. Lection, Raleigh, NC (US); Eric L. Masselle, Raleigh, NC (US)

(72) Inventors: David B. Lection, Raleigh, NC (US); Eric L. Masselle, Raleigh, NC (US)

(73) Assignee: INTERNATIONAL BUSINESS MACHINES CORPORATION, Armonk, NY (US)

(21) Appl. No.: 13/216,574

(22) Filed: Aug. 24, 2011

(51) Int. Cl. G06Q 30/00; G06F 17/30

(52) U.S. Cl. 705/14.1; 707/758; 707/E17.014

(57) ABSTRACT

Providing distributed energy contribution-based commuting services includes receiving transportation schedules from a community of transportation service providers and receiving capacity information and energy contribution data from the community of transportation service providers. The energy contribution data specifies a number of docking stations, per vehicle, configured to receive energy sources from passengers. The distributed energy contribution-based commuting services also include receiving criteria from a user, the criteria specifying trip information including pick up location, destination, time of trip and available energy source. The user is a prospective passenger. The distributed energy contribution-based commuting services also includes searching a database of the transportation schedules for the criteria, and presenting a schedule from the database of transportation schedules that matches the criteria. The criteria are considered matched when at least one docking station in a vehicle is available.

### BACKGROUND

The present invention relates to energy conservation, and more specifically, to distributed energy contribution-based commuting.

With the rising costs of energy, many individuals are seeking ways to conserve on power usage. Electric and hybrid vehicles are becoming more popular for those who seek to be less dependent on fossil fuels. Ride sharing, in which two or more individuals car pool to and from work, can also be a useful way to save on energy usage. Public transportation is another way in which people can conserve fuel. Despite these options, however, uncertainties in terms of the availability and costs of fuel continue to cause many individuals and entities to further develop alternate methods of conserving energy.

### SUMMARY

According to one embodiment of the present invention, a method for providing distributed energy contribution-based commuting services is provided. The method includes receiving transportation schedules from a community of transportation service providers and receiving capacity information and energy contribution data from the community of transportation service providers. The energy contribution data specifies a number of docking stations, per vehicle, configured to receive energy sources from passengers. The method also includes receiving criteria from a user, the criteria specifying trip information including pick up location, destination, time of trip and available energy source. The user is a prospective passenger. The method further includes searching a database of the transportation schedules for the criteria and presenting a schedule from the database of transportation schedules that matches the criteria. The criteria are matched when at least one docking station in a vehicle is available.

According to another embodiment of the present invention, a system providing distributed energy contribution-based commuting services is provided. The system includes a host system computer and logic executable by the host system computer. The logic is configured to implement a method. The method includes receiving transportation schedules from a community of transportation service providers and receiving capacity information and energy contribution data from the community of transportation service providers. The energy contribution data specifies a number of docking stations, per vehicle, configured to receive energy sources from passengers. The method also includes receiving criteria from a user, the criteria specifying trip information including pick up location, destination, time of trip and available energy source. The user is a prospective passenger. The method further includes searching a database of the transportation schedules for the criteria and presenting a schedule from the database of transportation schedules that matches the criteria. The criteria are matched when at least one docking station in a vehicle is available.

According to a further embodiment of the present invention, a computer program product for providing distributed energy contribution-based commuting services is provided. The computer program product includes a storage medium embedded with program instructions, which when executed by a computer cause the computer to implement a method. The method includes receiving transportation schedules from a community of transportation service providers and receiving capacity information and energy contribution data from the community of transportation service providers. The energy contribution data specifies a number of docking stations, per vehicle, configured to receive energy sources from passengers. The method also includes receiving criteria from a user, the criteria specifying trip information including pick up location, destination, time of trip and available energy source. The user is a prospective passenger. The method further includes searching a database of the transportation schedules for the criteria and presenting a schedule from the database of transportation schedules that matches the criteria. The criteria are matched when at least one docking station in a vehicle is available.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which commuter services may be implemented according to an embodiment of the present invention;

FIG. 2 depicts a flow diagram describing a process for implementing commuter services according to an embodiment of the present invention; and

FIG. 3 depicts a user interface screen provided by the commuter services according to an embodiment of the present invention.

### DETAILED DESCRIPTION

According to an exemplary embodiment, commuter services are provided. The commuter services enable passengers of vehicles to contribute their own energy to the vehicles in return for a free or reduced fee ride in the vehicles. The exemplary commuter services provide the ability to match transport-providing users with those who wish to be transported based on commuting information and time information.

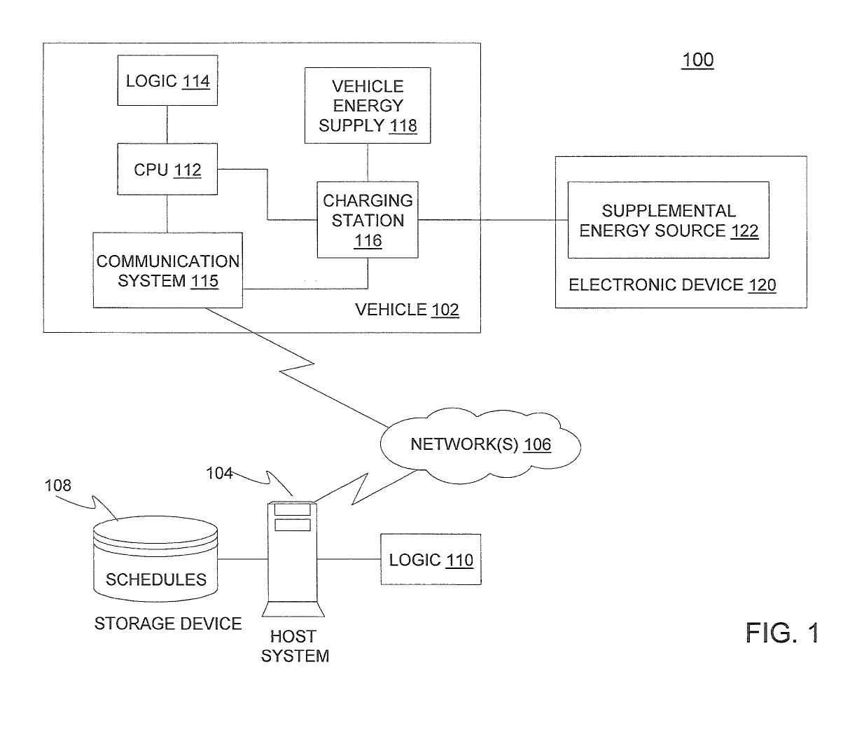

Turning now to FIG. 1, a system 100 upon which the commuter services may be implemented will now be described in an exemplary embodiment. The system 100 of FIG. 1 includes a portion of a vehicle 102 in communication with a host system 104 over one or more networks 106. The host system 104 represents an entity that facilitates the commuter services on behalf of its users, e.g., an operator of the vehicle 102. The host system 104 may be implemented as a high-speed computer processing device (e.g., a mainframe computer) that is capable of handling a large volume of activities conducted by the users of the commuter services.

The host system 104 executes logic 110 for providing the exemplary commuter services described herein. The logic 110 is configured to generate and search one or more databases of information, which are stored in a storage device 108 for use in creating transportation schedules and user records for use in implementing the commuter services. The storage device 108 stores the transportation schedules and user records, and the logic 110 queries the databases for matching the transport-providing users to corresponding users who wish to be transported, as will be described further herein.

The networks 106 may include any type of networks, such as local area networks, wide area networks, virtual private networks, and the Internet. In addition, the networks 106 may be configured to support wireless communications, e.g., via cellular networks, satellite networks, and global positioning systems.

In an exemplary embodiment, the vehicle 102 includes one or more computer processing units (CPUs) 112. The CPU 112 may be integrated with a control system of the vehicle 102 that communicates with various vehicle components. As shown in FIG. 1, the CPU 112 is communicatively coupled to a communication system 115 and a charging station 116. The communication system 115 includes wireless transmission components for enabling the CPU 112 to communicate with the host system 104 over the networks 106. For example, the communication system 115 may include a roadside assistance system that is capable of transmitting information from an operator of the vehicle 102 to a service provider. The CPU 112 executes logic 114 configured to monitor energy consumption of an energy supply 118 of the vehicle 102. For example, the logic 114 tracks the amount of electrical power consumed by a battery (power supply 118), e.g., in terms of units of power, while in operation. In one embodiment, the logic 114 receives this information through the charging station 116. The charging station 116 includes a coupling mechanism (not shown) that couples the charging station 116 to the vehicle energy supply 118 for providing energy to the energy supply 118. The charging station 116 also includes a coupling mechanism (not shown) that couples the charging station 118 to a supplemental energy source 122.

In an alternative exemplary embodiment, the logic 110 executing on the host system 104 may be configured to monitor and track the energy consumption described above with respect to the logic 114.

In an exemplary embodiment, the supplemental energy source 122 refers to a source of energy that is provided by a passenger (ride share recipient) in the vehicle 102. The supplemental energy source 122 may be a battery for a laptop or other electronic device 120 that provides electrical power. Alternatively, the supplemental energy source 122 may be a fuel cell. It will be understood, however, that the energy may be any type of rechargeable or renewable energy supply, and is not limited to electrical power. For example, the energy supply may be portable fossil fuels or nuclear energy. The supplemental energy source 122 may couple with the charging station 116 via an adapter. When the supplemental energy source 122 is coupled with the charging station 116, the charging station 116 receives the energy (e.g., electrical power) from the supplemental energy source 118 and provides the energy to the vehicle energy supply 118. This process may involve notifying the CPU 112 that the supplemental energy source 122 is engaged, whereby the CPU 112 sends a signal to the vehicle energy supply 118 to discontinue powering the vehicle 102 engine (not shown) and to receive the energy provided via the charging station 116. In an alternative embodiment, the logic 114 may be configured to use the supplemental energy source 122 to charge the vehicle energy supply 118.

As indicated above, the exemplary commuter services may be provided for individual commuters, as well as larger transportation provider systems, such as bus lines, trains, and subways. In a larger transportation provider system, contributed or supplemental energy may be implemented through multiple docking stations that are disposed in the transport vehicle. The docking station is similar in function to the charging station 116 except that it may be configured for receiving larger, high-powered energy sources that would otherwise be unsuitable for smaller vehicles. For example, a passenger on a bus may be wheeling a briefcase carrying an uninterruptible power supply (UPS) device or back up power supply. In this embodiment, the passenger may be directed to the docking station and engages the UPS device with the docking station. The collective power received from the power supplies offered by the passengers can significantly reduce the amount of energy needed by the bus line. The bus line may then offer the passengers a discounted rate for the commute based on the length of time the supplemental energy supply is engaged in the docking station, a defined segment of a route traveled by the passenger, or the amount of energy received from the supplemental energy supply, as tracked by the docking station.

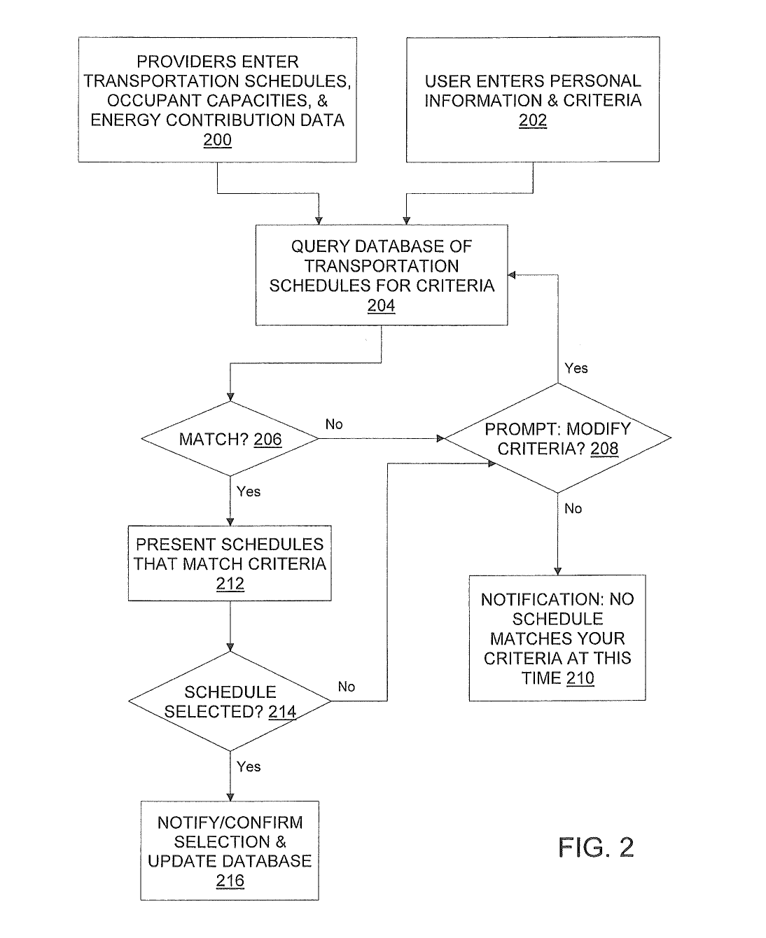

In an exemplary embodiment, the commuter services may be configured to process the energy contributions of the users of the services, and notify the users of the amount of money they saved in their commutes by using the services by subtracting the value of the energy contributions from the costs of paying full price for a commute. These, and other features of the commuter services will now be described in FIG. 2.

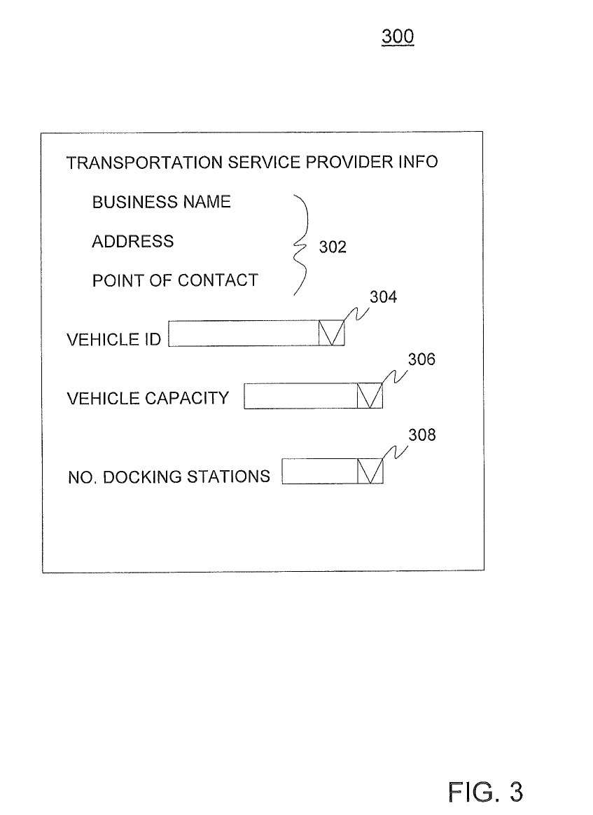

Turning now to FIG. 2, a flow diagram describing a process for implementing the commuter services will now be described in an exemplary embodiment. In one embodiment, the services provide a web-based interface for receiving transportation provider and passenger information. A sample user interface 300 is shown in FIG. 3.

At step 200, transportation providers enter transportation schedules, occupant capacities, and energy contribution data into a web page provided by the commuter services via the host system 104. The transportation providers may each be host to a specific passenger transportation business including train, bus, subway, etc. and are referred to collectively as a transportation provider community. As shown, e.g., in FIG. 3 a simplified user interface screen 300 illustrates fields of data requested by the services. For example, the transportation provider enters provider information 302, such as business name, address, point of contact, etc. In addition, the transportation provider enters vehicle and scheduling information. As shown, for example, in FIG. 3, the transportation provider enters a vehicle identification number 304 for each vehicle in its service. In addition, the transportation provider enters capacity information 306 that provides the total number (maximum) of passenger seating for the vehicle. Also, the transportation provider enters the number of docking stations 308 provided on the vehicle. The logic 110 further prompts the transportation provider to enter scheduling information for each vehicle, such as routes, pick up and drop off locations, and times corresponding to these schedules (not shown). The logic 110 stores this information as ‘schedules’ in the storage device 108.

At step 202, a user (e.g., potential passenger) enters personal identifying information (e.g., name, address, etc.) and criteria into another web page (not shown) provided by the logic 114. The criteria entered by the user relates to trip details, such as pick up and drop off location preferences, dates and times of travel, and the ability to contribute energy to the trip. For example, the user may commit to contributing energy three of the five days a week in which transportation is desired. Alternatively, the user may commit to contributing energy for a specified segment of a trip, as described further herein. The criteria may also include preferred transport systems (e.g., bus versus subway, or public transit versus private transit). The criteria may also include the type of energy to be contributed by the passenger (e.g., electrical power, fossil fuels, nuclear power, etc.). The logic 110 stores the user information and criteria in the storage device 108.

At step 204, the logic 110 queries the database(s) in the storage device 108 for transportation providers and schedules that match the criteria provided by a passenger. The logic 110 may be configured to intelligently and dynamically update the availability of docking stations, as well as occupancy statuses in the schedules as user requests are matched with scheduled trips and vehicles, which may then be used in determining the availability of a vehicle for a particular passenger request.

At step 206, it is determined whether the query resulted in a match. If there is no match in response to the query, the logic 110 may be configured to prompt the user to modify the criteria entered in order to broaden the search for available vehicles at step 208. If the user accepts this suggestion, the user re-enters the criteria the logic 110 conducts another search at step 204.

However, if a match has occurred at step 206, the logic 110 presents the schedules matching the user's criteria at step 212 and directs the user to select from the list. At step 214, the logic 110 determines whether the user has selected a schedule. If the user has not selected a schedule (e.g., the user is not satisfied with the choices on the list), the logic 110 prompts the user to modify the criteria at step 208 and the search is repeated at step 204. Otherwise, if a schedule has been selected by the user at step 214, the logic 110 sends a confirmation of the selection to the user and updates the database(s) in the storage device 108 to reflect, e.g., an updated number of occupancies for a corresponding vehicle, as well as an updated number of available docking stations.

In one exemplary embodiment, the transportation schedules may be broken down into segments that are defined, e.g., by locations along a route. In defining each route by segments, the logic 110 is configured to enable a passenger to select one or more segments of a route in which he/she will provide or contribute energy. This may be useful especially for long trips. The user may select a segment via the web page provided by the services. Likewise, the logic 110 may be configured to enable a transportation provider system to define its routes by segments as desired.

It will be understood that the processes described in steps 200 and 202 may be performed in any order and that the steps 200-216 may be ongoing or continuously performed processes, e.g., as new transportation providers and passengers are added to the services, and as new schedules and trips are planned or updated in the future.

Technical effects of the invention include the ability to enable distributed contribution of energy in a commuter transportation system. Passengers of a transportation system provide energy supplies, such as laptop batteries, which are coupled with a charging station of the transportation system to contribute energy to the commute in which the passenger is engaged. The passengers may be offered reduced fares in turn for the contribution of energy.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for providing distributed energy contribution-based commuting services, the method comprising:
receiving transportation schedules from a community of transportation service providers;
receiving capacity information and energy contribution data from the community of transportation service providers, the energy contribution data specifying a number of docking stations, per vehicle, configured to receive energy sources from passengers;
receiving criteria from a user, the criteria specifying trip information including pick up location, destination, time of trip and available energy source, wherein the user is a prospective passenger;
searching a database of the transportation schedules for the criteria;
presenting a schedule from the database of transportation schedules that matches the criteria, the criteria matched when at least one docking station in a vehicle is available.

2. The method of claim 1, wherein the capacity information specifies a maximum amount of passengers capable of being transported by the vehicle.

3. The method of claim 1, wherein the transportation schedules include defined segments of the transportation schedules, the defined segments collectively specifying a route, and the defined segments classified by pick up and drop off locations along the route.

4. The method of claim 1, further comprising:
receiving transportation service provider vehicle types, the transportation service provider vehicle types including buses, trains, and subways;
wherein the criteria from the user includes one of the transportation service provider vehicle types.

5. The method of claim 1, further comprising:
monitoring an amount of energy contributed by the user as a passenger; and
reducing an amount of fare for a commute by a value of the amount of energy contributed by the energy source provided by the passenger.

6. The method of claim 1, wherein the energy source is a renewable energy source comprising one of a battery and a fuel cell, the energy contributed by the user is electrical power, and the electrical power is provided through the docking station to charge the vehicle.

7. The method of claim 1, wherein the energy source is a renewable energy source comprising at least one of a:
battery;
a fuel cell;
portable fossil fuel; and
nuclear energy.

8. A system for providing distributed energy contribution-based commuting services, the system comprising:
a host system computer; and
logic executable by the host system computer, the logic configured to implement a method, the method comprising:
receiving transportation schedules from a community of transportation service providers;
receiving capacity information and energy contribution data from the community of transportation service providers, the energy contribution data specifying a number of docking stations, per vehicle, configured to receive energy sources from passengers;
receiving criteria from a user, the criteria specifying trip information including pick up location, destination, time of trip and available energy source, wherein the user is a prospective passenger;
searching a database of the transportation schedules for the criteria;
presenting a schedule from the database of transportation schedules that matches the criteria, the criteria matched when at least one docking station in a vehicle is available.

9. The system of claim 8, wherein the capacity information specifies a maximum amount of passengers capable of being transported by the vehicle.

10. The system of claim 8, wherein the transportation schedules include defined segments of the transportation schedules, the defined segments collectively specifying a route, and the defined segments classified by pick up and drop off locations along the route.

11. The system of claim 8, wherein the logic is further configured to implement:
receiving transportation service provider vehicle types, the transportation service provider vehicle types including buses, trains, and subways;
wherein the criteria from the user includes one of the transportation service provider vehicle types.

12. The system of claim 8, wherein the logic is further configured to implement:
monitoring an amount of energy contributed by the user as a passenger; and
reducing an amount of fare for a commute by a value of the amount of energy contributed by the energy source provided by the passenger.

13. The system of claim 8, wherein the energy source is a renewable energy source comprising one of a battery and a fuel cell, the energy contributed by the user is electrical power, and the electrical power is provided through the docking station to charge the vehicle.

14. The system of claim 8, wherein the energy source is a renewable energy source comprising at least one of a:
battery;
a fuel cell;
portable fossil fuel; and
nuclear energy.

15. A computer program product for providing distributed energy contribution-based commuting services, computer program product comprises a storage medium embodied with machine-readable program instructions, which when executed by a computer, cause the computer to implement a method, the method comprising:
receiving transportation schedules from a community of transportation service providers;
receiving capacity information and energy contribution data from the community of transportation service providers, the energy contribution data specifying a number of docking stations, per vehicle, configured to receive energy sources from passengers;
receiving criteria from a user, the criteria specifying trip information including pick up location, destination, time of trip and available energy source, wherein the user is a prospective passenger;
searching a database of the transportation schedules for the criteria;
presenting a schedule from the database of transportation schedules that matches the criteria, the criteria matched when at least one docking station in a vehicle is available.

16. The computer program product of claim 15, wherein the capacity information specifies a maximum amount of passengers capable of being transported by the vehicle.

17. The computer program product of claim 15, wherein the transportation schedules include defined segments of the transportation schedules, the defined segments collectively specifying a route, and the defined segments classified by pick up and drop off locations along the route.

18. The computer program product of claim 15, wherein the program instructions further implement:
receiving transportation service provider vehicle types, the transportation service provider vehicle types including buses, trains, and subways;
wherein the criteria from the user includes one of the transportation service provider vehicle types.

19. The computer program product of claim 15, wherein the program instructions further implement:
monitoring an amount of energy contributed by the user as a passenger; and
reducing an amount of fare for a commute by a value of the amount of energy contributed by the energy source provided by the passenger.

20. The computer program product of claim 15, wherein the energy source is a renewable energy source comprising at least one of a:
battery;
a fuel cell;
portable fossil fuel; and
nuclear energy.
